(19) United States
(12) Patent Application Publication
(10) Pub. No.: US 2025/0219065 A1
(43) Pub. Date: Jul. 3, 2025

(54) ELECTRODE ACTIVE MATERIAL, ELECTRODE MIXTURE, ELECTRODE LAYER, BATTERY, AND METHOD FOR PRODUCING THESE

(71) Applicant: TOYOTA JIDOSHA KABUSHIKI KAISHA, Toyota-shi (JP)

(72) Inventors: Mitsutoshi OTAKI, Shizuoka-ken (JP); Masafumi Nose, Mishima-shi (JP)

(73) Assignee: TOYOTA JIDOSHA KABUSHIKI KAISHA, Toyota-shi (JP)

(21) Appl. No.: 18/980,155

(22) Filed: Dec. 13, 2024

(30) Foreign Application Priority Data
Dec. 28, 2023 (JP) 2023-223258

(51) Int. Cl. H01M 4/38; C01B 33/021; H01M 4/02

(52) U.S. Cl. CPC H01M 4/386; C01B 33/021; C01P 2002/72; C01P 2002/77; C01P 2006/40; H01M 2004/021

(57) ABSTRACT

A main object of the present disclosure is to provide an electrode active material of which volume change due to charge and discharge is small. The present disclosure achieves the object by providing an electrode active material including a silicon clathrate II type crystal phase, wherein a void is included inside a primary particle; and a void amount P₁ of a void with a pore diameter of 5 nm or less is 0.015 cc/g or more and 0.05 cc/g or less.

### TECHNICAL FIELD

The present disclosure relates to an electrode active material, an electrode mixture, an electrode layer, a battery, and a method for producing these.

### BACKGROUND ART

In recent years, the development of a battery has been actively carried out. For example, the development of a battery used for battery electric vehicles (BEV), plug-in hybrid electric vehicles (PHEV), or hybrid electric vehicles (HEV) has been advanced in the automobile industry. Also, as an electrode active material used for a battery, a Si (silicon) has been known. For example, Patent Literature 1 discloses an electrode active material including a silicon clathrate II type crystal phase and a void inside a primary particle.

### CITATION LIST

### Patent Literature

Patent Literature 1: Japanese Patent Application Laid-Open (JP-A) No. 2023-044620

### SUMMARY OF DISCLOSURE

### Technical Problem

The theoretical capacity of Si is large and it is advantageous to allow a battery to have high energy density. On the other hand, the volume change of Si during charge and discharge is large. When the volume change during charge and discharge is large, for example, there is a problem such that the function of an electrode tends to be degraded when charge and discharge are repeated.

The present disclosure has been made in view of the above circumstances and a main object thereof is to provide an electrode active material of which volume change due to charge and discharge is small.

### Solution to Problem

[1]

An electrode active material comprising a silicon clathrate II type crystal phase, wherein
a void is included inside a primary particle; and
a void amount P₁ of a void with a pore diameter of 5 nm or less is 0.015 cc/g or more and 0.05 cc/g or less.
   [2]

The electrode active material according to [1], wherein a rate of the void amount P₁ with respect to a void amount P₂ of a void with a pore diameter of 10 nm or less, which is P₁/P₂, is 50% or more.

[3]

The electrode active material according to [1] or [2], wherein a void amount P₂ of a void with a pore diameter of 10 nm or less is 0.03 cc/g or more and 0.08 cc/g or less.

[4]

The electrode active material according to any one of [1] to [3], wherein a rate of the void amount P₁ with respect to a void amount P₃ of a void with a pore diameter of 100 nm or less, which is P₁/P₃, is 6.5% or more.

[5]

The electrode active material according to any one of [1] to [4], wherein a void amount P₃ of a void with a pore diameter of 100 nm or less is 0.1 cc/g or more and 0.5 cc/g or less.

[6]

The electrode active material according to any one of [1] to [5], wherein the electrode active material includes the silicon clathrate II type crystal phase as a main phase.

[7]

An electrode mixture comprising the electrode active material according to any one of [1] to [6], and at least one of a conductive material and a binder.

[8]

The electrode mixture according to [7], further comprising a solid electrolyte.

[9]

The electrode mixture according to [8], wherein the solid electrolyte included in the electrode mixture is a sulfide solid electrolyte.

[10]

An electrode layer to be used in a battery, the electrode layer comprising:
an electrode active material including a silicon clathrate II type crystal phase and a void inside a primary particle, wherein
a void amount Q₁ of a void with a pore diameter of 5 nm or less is 0.008 cc/g or more and 0.04 cc/g or less.
   [11]

The electrode layer according to [10], wherein a rate of the void amount Q₁ with respect to a void amount Q₂ of a void with a pore diameter of 10 nm or less, which is Q₁/Q₂, is 50% or more.

[12]

The electrode layer according to or [11], wherein a void amount Q₂ of a void with a pore diameter of 10 nm or less is 0.01 cc/g or more and 0.05 cc/g or less.

[13]

The electrode layer according to any one of [10] to [12], wherein a rate of the void amount Q₁ with respect to a void amount Q₃ of a void with a pore diameter of 100 nm or less, which is Q₁/Q₃, is 10% or more.

[14]

The electrode layer according to any one of [10] to [13], wherein a void amount Q₃ of a void with a pore diameter of 100 nm or less is 0.07 cc/g or more and 0.2 cc/g or less.

[15]

A battery comprising a cathode layer, an anode layer, and an electrolyte layer arranged between the cathode layer and the anode layer, wherein
the cathode layer or the anode layer is the electrode layer according to any one of [10] to [14].
   [16]

A method for producing an electrode active material, the method comprising:
an alloying step of obtaining a Na—Si alloy by bringing a Na source and a Si source into reaction;
a burning step of burning the Na—Si alloy to decrease Na amount in the Na—Si alloy and form a precursor active material including a silicon clathrate II type crystal phase; and
a liquid treatment step of performing a liquid treatment to the precursor active material using a hydrofluoric acid, wherein
a concentration of hydrogen fluoride in the hydrofluoric acid is 3 weight % or more; and
a treatment time in the liquid treatment step is 3 hours or more and less than 24 hours.
   [17]

The method for producing an electrode active material according to [16], wherein, in the electrode active material, a void amount P₁ of a void with a pore diameter of 5 nm or less is 0.015 cc/g or more and 0.05 cc/g or less.

[18]

A method for producing an electrode mixture, the method comprising:
a preparing step of preparing an electrode active material by the method for producing an electrode active material according to [16] or [17]; and
a mixing step of mixing the electrode active material and at least one of a conductive material and a binder to obtain an electrode mixture.
   [19]

A method for producing an electrode layer, the method comprising:
a preparing step of preparing an electrode active material by the method for producing an electrode active material according to [16] or [17];
a mixing step of mixing the electrode active material and at least one of a conductive material and a binder to obtain an electrode mixture; and
an electrode layer forming step of forming an electrode layer using the electrode mixture.
   [20]

A method for producing a battery, the method comprising:
a preparing step of preparing an electrode active material by the method for producing an electrode active material according to [16] or [17];
a mixing step of mixing the electrode active material and at least one of a conductive material and a binder to obtain an electrode mixture; and
an electrode layer forming step of forming an electrode layer using the electrode mixture.

### Advantageous Effects of Disclosure

The present disclosure exhibits an effect such that an electrode active material of which volume change due to charge and discharge is small is obtained.

### BRIEF DESCRIPTION OF DRAWINGS

FIGS. 1A and 1B are schematic perspective views explaining the crystal phase of Si.

FIG. 2 is a schematic cross-sectional view exemplifying the battery in the present disclosure.

FIG. 3 is a flow chart exemplifying the method for producing the electrode active material in the present disclosure.

FIG. 4 is an XRD chart of an active material before and after the liquid treatment with a HF aqueous solution.

### DESCRIPTION OF EMBODIMENTS

The electrode active material, the electrode mixture, the electrode layer, the battery, and the method for producing these in the present disclosure will be hereinafter explained in details.

### A. Electrode Active Material

The electrode active material in the present disclosure includes a silicon clathrate II type crystal phase and a void inside a primary particle. Also, a void amount P₁ of a void with a pore diameter of 5 nm or less is large.

According to the present disclosure, the void amount P₁ is large, and thus the volume change of the electrode active material due to charge and discharge is small. The inventors of the present disclosure have had obtained knowledge from previous studies that the crashing of a void by a pressing process was inhibited by increasing the void amount of a minute void with a pore diameter of 100 nm or less. Further, it has been found out that, by increasing the void amount of a minute void with the pore diameter of 10 nm or less, a filling rate of the deposited Li in a void can be increased at the same time of remarkably inhibiting the crash of the void by the pressing process, and thereby the volume change due to charge and discharge was effectively suppressed.

In contrast, in the present disclosure, it has been found out that, for example, by positively performing a liquid treatment with a hydrofluoric acid, the void amount P₁ of a minute void with a pore diameter of 5 nm or less can be increased. The reason therefor is presumed that the deposited Li is filled in the minute void with the pore diameter of 5 nm or less on a priority basis during charge. It is presumed that, by positively performing the liquid treatment with a hydrofluoric acid, the silicon clathrate I type crystal phase included in the electrode active material disappears at the same time of etching of the surface of the electrode active material is done, and thereby the void amount P₁ increases. When the void amount P₁ increases, the volume change due charge and discharge can be effectively suppressed.

Further, the electrode active material in the present disclosure includes a silicon clathrate II type crystal phase. As shown in FIG. 1A, in the silicon clathrate II type crystal phase, a plurality of Si elements form a polyhedron (cage) including pentagons and hexagons. This polyhedron has a space inside to include metal ions such as Li ions. The metal ions are intercalated to this space to inhibit the volume change due to charge and discharge. Particularly in a solid state battery, in order to suppress the volume change due to charge and discharge, in general, it is necessary to apply a high restraining pressure, but by using the electrode active material in the present disclosure, reduction of the restraining pressure can be achieved, and as a result, the increase in size of the restraining jig can be suppressed. Meanwhile, as shown in FIG. 1B, in the diamond type silicon crystal phase, a plurality of Si elements form a tetrahedron. The tetrahedron does not have a space inside to include metal ions such as Li ions, and thus its volume change due to charge and discharge cannot be easily suppressed by the diamond type silicon crystal phase compared to the silicon clathrate II type crystal phase.

The shape of the active material in the present disclosure is usually a granular shape. The active material may be a primary particle, and may be a secondary particle which is aggregation of the primary particles. In both cases, a void is included inside a primary particle.

It is preferable that the electrode active material includes a lot of voids with the pore diameter of 5 nm or less. The void amount P₁ of a void with the pore diameter of 5 nm or less is usually 0.015 cc/g or more, may be 0.020 cc/g or more, and may be 0.023 cc/g or more. Meanwhile, the void amount P₁ is usually 0.05 cc/g or less, may be 0.04 cc/g or less, and may be 0.035 cc/g or less. The void amount in the present disclosure means an integrating hole volume, and can be obtained by, for example, a BET measurement, a gas absorption method, a mercury porosimeter measurement, 3D-SEM, and 3D-TEM.

It is preferable that the electrode active material includes a lot of voids with the pore diameter of 10 nm or less. The void amount P₂ of a void with the pore diameter of 10 nm or less is, for example, 0.03 cc/g or more, may be 0.035 cc/g or more, and may be 0.04 cc/g or more. Meanwhile, the void amount P₂ is, for example, 0.08 cc/g or less, may be 0.07 cc/g or less, and may be 0.06 cc/g or less. Also, the rate of the void amount P₁ with respect to the void amount P₂, which is P₁/P₂ is, for example, 50% or more, may be 55% or more, and may be 57% or more. Meanwhile, P₁/P₂ is, for example, 80% or less, may be 70% or less, and may be 65% or less.

It is preferable that the electrode active material includes a lot of voids with the pore diameter of 100 nm or less. The void amount P₃ of a void with the pore diameter of 100 nm or less is, for example, 0.1 cc/g or more, may be 0.2 cc/g or more, and may be 0.32 cc/g or more. Meanwhile, the void amount P₃ is, for example, 0.5 cc/g or less, may be 0.45 cc/g or less, and may be 0.38 cc/g or less. Also, the rate of the void amount P₁ with respect to the void amount P₃, which is P₁/P₃ is, for example, 6.0% or more, may be 6.5% or more, and may be 6.9% or more. Meanwhile, P₁/P₃ is, for example, 15% or less, may be 12% or less, and may be 10% or less.

The electrode active material preferably includes a void inside the primary particle. The rate of the void (void rate) in the primary particle is, for example, 4% or more, and may be 10% or more. Also, the void rate is, for example, 40% or less and may be 20% or less. The void rate can be obtained by, for example, in the following procedures. First, an ion milling processing is performed to the electrode layer including the electrode active material to take out the cross-section. Then, the cross-section is observed by a SEM (scanning electron microscope) to obtain a picture of particles. From the obtained picture, a silicon portion and the void portion are distinguished using an image analyzing software, and binarized. The areas of the silicon portion and the void portion are obtained, and the void rate (%) is calculated from the below equation.

Void rate (%)=100*(Area of void portion)/((Area of silicon portion)+(Area of void portion))

The average particle size (D₅₀) of the electrode active material is not particularly limited, and for example, it is 0.1 μm or more and 50 μm or less, and may be 0.5 μm or more and 30 μm or less. The average particle size (D₅₀) may be calculated from, for example, a measurement with a scanning electron microscope (SEM). Also, the BET specific surface area of the electrode active material is not particularly limited, and for example, it is 30 m²/g or more, may be 40 m²/g or more, may be 50 m²/g or more, and may be 60 m²/g or more. Meanwhile, the BET specific surface area of the electrode active material is, for example, 150 m²/g or less.

The electrode active material includes a silicon clathrate II type crystal phase. Above all, the electrode active material preferably includes the silicon clathrate II type crystal phase as a main phase. “Main phase” means that the peak belonging to that crystal phase has the largest diffraction intensity among the peaks observed in an X-ray diffraction measurement. The proportion of the silicon clathrate II type crystal phase included in the electrode active material is, for example, 80 weight % or more, may be 85 weight % or more, may be 90 weights or more, and may be 95 weight % or more. Also, the proportion of the silicon clathrate II type crystal phase included in the electrode active material may be 100 weight %, and may be less than 100 weight %. The proportion of the crystal phase can be obtained by performing a Rietveld analysis to the XRD measurement result, and using the analysis result and a RIR method (Reference Intensity Ratio method).

The silicon clathrate II type crystal phase usually belongs to the space group Fd-3m. In an X-ray diffraction measurement using a CuKα ray, the silicon clathrate II type crystal phase has typical peaks at the positions of 2θ=20.09°, 21.00°, 26.51°, 31.72°, 36.26°, and 53.01°. Each of these peaks may shift in the range of ±0.50°, may shift in the range of ±0.30°, and may shift in the range of ±0.10°.

In the silicon clathrate II type crystal phase, a peak positioned at 2θ=20.09°±0.50° is regarded as peak A, and a peak positioned at 2θ=31.72°±0.50° is regarded as peak B. Also, the intensity of the peak A is regarded as I_{A}, and the intensity of the peak B is regarded as I_{B}. Meanwhile, the maximum intensity in 2θ=22° to 23° is regarded as I_{M}. Since 2θ=22° to 23° is the range where peaks of crystal phase relating to Si does not usually appear, it can be used as the basis.

The value of I_{A}/I_{M} is preferably larger than 1. When the value of I_{A}/I_{M} is 1 or less, it can be judged that the silicon clathrate II type crystal phase is substantially not formed. The value of I_{A}/I_{M} is, for example, 1.75 or more and may be 1.80 or more. Meanwhile, the value of I_{A}/I_{M} is, for example, 10 or less, and may be 5 or less.

The value of I_{B}/I_{M} is preferably larger than 1. When the value of I_{B}/I_{M} is 1 or less, it can be judged that the silicon clathrate II type crystal phase is substantially not formed. The value of I_{B}/I_{M} is, for example, 1.35 or more, and may be 1.40 or more. Meanwhile, the value of I_{B}/I_{M} is, for example, 7 or less, and may be 4 or less.

The electrode active material in the present disclosure may or may not include a silicon clathrate I type crystal phase. “Not including a crystal phase” means that peaks of that crystal phase are not confirmed by an X-ray diffraction measurement. The silicon clathrate I type crystal phase usually belongs to a space group Pm-3n. The silicon clathrate I type crystal phase has typical peaks at the positions of 2θ=19.44°, 21.32°, 30.33°, 31.60°, 32.82°, 36.29°, 52.39°, and 55.49° in an X-ray diffraction measurement using a CuKα ray. Each of these peaks may shift in the range of ±0.50°, may shift in the range of ±0.30°, and may shift in the range of ±0.10°.

The electrode active material in the present disclosure may or may not include a diamond type silicon crystal phase. Also, in an X-ray diffraction measurement using a CuKα ray, the diamond type silicon crystal phase has typical peaks at the positions of 2θ=28.44°, 47.31°, 56.10°, 69.17°, and 76.37°. Each of these peaks may shift in the range of ±0.50°, may shift in the range of ±0.30°, and may shift in the range of ±0.10°.

When a peak C positioned at 2θ=28.44°+0.50° is observed as the peak of the diamond type silicon crystal phase, the intensity of the peak C is regarded as I_{C}. I_{A}/I_{C} is, for example, larger than 1, may be 1.5 or more, may be 2 or more, and may be 3 or more. Preferable range of I_{B}/I_{C} is the same as the preferable range of I_{A}/I_{C}.

The composition of the electrode active material in the present disclosure is not particularly limited, but is preferably represented by NaₓSi₁₃₆ (0≤x≤24). The “x” may be 0 and may be larger than 0. Meanwhile, the “x” may be 20 or less, may be 10 or less, and may be 5 or less. The composition of the electrode active material may be obtained by, for example, EDX, XRD, XRF, ICP, and an atomic absorption method. Incidentally, on the surface of the electrode active material, in general, an inevitable oxidized film is formed. For this reason, the electrode active material may contain a little amount of O (oxygen). Also, the electrode active material may contain a little amount of C (carbon) derived from the production steps.

The electrode active material in the present disclosure is usually used for a battery. The electrode active material in the present disclosure may be an anode active material and may be a cathode active material, but the former is preferable. Examples of the method for producing the electrode active material may include the production method described in “E. Method for producing electrode active material” later.

### B. Electrode Mixture

The electrode mixture in the present disclosure contains the above described electrode active material, and at least one of a conductive material and a binder.

According to the present disclosure, usage of the above described electrode active material allows the electrode mixture to have less volume change due to charge and discharge.

The electrode mixture contains the electrode active material and at least one of a conductive material and a binder. The electrode active material is in the same contents as those described in “A. Electrode active material” above. The electrode active material may be an anode active material and may be a cathode active material, but the former is preferable. In other words, the electrode mixture may be an anode mixture, and may be a cathode mixture, but the former is preferable.

The proportion of the electrode active material in the electrode mixture is, for example, 20 weight % or more, may be 30 weight % or more and may be 40 weight % or more. If the proportion of the electrode active material is too little, there is a possibility that sufficient energy density may not be obtained. Meanwhile, the proportion of the electrode active material is, for example, 80 weight % or less, may be 70 weight % or less, and may be 60 weight % or less. If the proportion of the electrode active material is too much, there is a possibility that the ion conductivity and the electron conductivity in the electrode mixture may be relatively degraded.

The electrode mixture contains at least one of a conductive material and a binder. Examples of the conductive material may include a carbon material, a metal particle, and a conductive polymer. Examples of the carbon material may include a particulate carbon material such as acetylene black (AB) and Ketjen black (KB), and a fiber carbon material such as carbon fiber, carbon nanotube (CNT), and carbon nanofiber (CNF). Further, examples of the binder may include a rubber-based binder and a fluoride-based binder.

The electrode mixture may further contain a solid electrolyte. Examples of the solid electrolyte may include an inorganic solid electrolyte such as a sulfide solid electrolyte, an oxide solid electrolyte, a nitride solid electrolyte, and a halide solid electrolyte; and an organic polymer electrolyte such as a polymer electrolyte. Examples of the sulfide solid electrolyte may include a solid electrolyte containing a Li element, an X element (X is at least one kind of P, As, Sb, Si, Ge, Sn, B, Al, Ga, and In), and a S element. Also, the sulfide solid electrolyte may further contain at least one of an O element and a halogen element. Examples of the halogen element may include a F element, a Cl element, a Br element, and an I element. The sulfide solid electrolyte may be glass (amorphous), and may be a glass ceramic. Examples of the sulfide solid electrolyte may include Li₂S—P₂S₅, LiI—Li₂S—P₂S₅, LiI—LiBr—Li₂S—P₂S₅, Li₂S—SiS₂, Li₂S—GeS₂, and Li₂S—P₂S₅—GeS₂. Also, the electrode mixture may further contain a dispersion medium.

### C. Electrode Layer

The electrode layer in the present disclosure is an electrode layer used for a battery, and includes an electrode active material including a silicon clathrate II type crystal phase and a void inside a primary particle. Also, there is a large amount of a void amount Q₁ of a void with a pore diameter of 5 nm or less.

According to the present disclosure, since the void amount Q₁ is large, the electrode layer has less volume change due to charge and discharge.

It is preferable that the electrode layer includes a lot of voids with the pore diameter of 5 nm or less. The void amount Q₁ of a void with the pore diameter of 5 nm or less is usually 0.008 cc/g or more, may be 0.010 cc/g or more, and may be 0.013 cc/g or more. Meanwhile, the void amount Q₁ is usually 0.04 cc/g or less, and may be 0.03 cc/g or less.

It is preferable that the electrode layer includes a lot of voids with the pore diameter of 10 nm or less. The void amount Q₂ of a void with the pore diameter of 10 nm or less is, for example, 0.01 cc/g or more, may be 0.015 cc/g or more, and may be 0.021 cc/g or more. Meanwhile, the void amount Q₂ is, for example, 0.05 cc/g or less, and may be 0.04 cc/g or less. Also, the rate of the void amount Q₁ with respect to the void amount Q₂, which is Q₁/Q₂ is, for example, 50% or more, and may be 56.9% or more. Meanwhile, the Q/Q₂ is, for example, 90% or less, and may be 80% or less.

It is preferable that the electrode layer includes a lot of voids with the pore diameter of 100 nm or less. The void amount Q₃ of a void with the pore diameter of 100 nm or less is, for example, 0.07 cc/g or more, may be 0.08 cc/g or more, and may be 0.09 cc/g or more. Meanwhile, the void amount Q₃ is, for example, 0.2 cc/g or less, may be 0.15 cc/g or less, and may be 0.12 cc/g or less. Also, the rate of the void amount Q₁ with respect to the void amount Q₃, which is Q/Q₃ is, for example, 10% or more, may be 12% or more, and may be 13% or more. Meanwhile, Q₁/Q₃ is, for example, 25% or less, may be 23% or less, and may be 20% or less.

The electrode layer contains an electrode active material, and at least one of a conductive material and a binder. Also, the electrode layer may contain an electrolyte. The materials, compositions, and other matters of these are in the same contents as those described in “A. Electrode active material” above and “B. Electrode mixture” above. The electrode layer may be an anode layer and may be a cathode layer, but the former is preferable. The thickness of the electrode layer is, for example, 0.1 μm or more and 1000 μm or less, may be 0.1 μm or more and 500 μm or less, and may be 0.1 μm or more and 100 μm or less. Also, examples of the method for producing the electrode layer may include a production method described in “F. Method for producing electrode layer” later.

### D. Battery

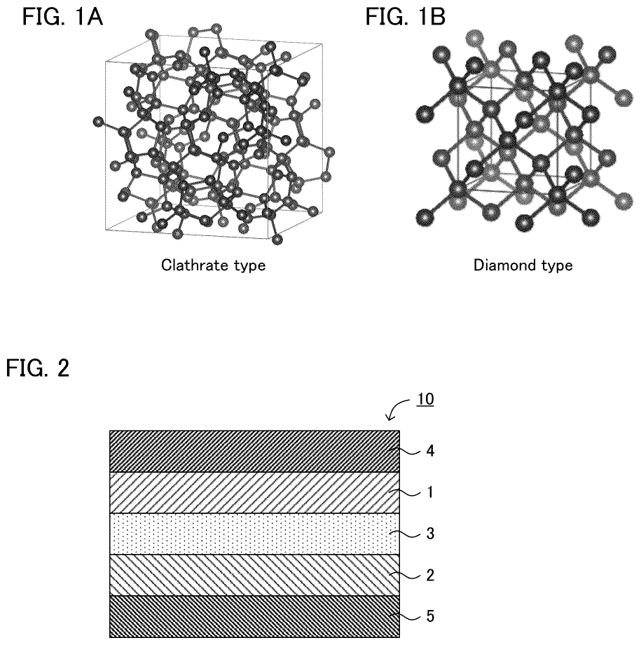

FIG. 2 is a schematic cross-sectional view exemplifying the battery in the present disclosure. Battery 10 shown in FIG. 2 includes cathode layer 1, anode layer 2, electrolyte layer 3 arranged between the cathode layer 1 and the anode layer 2, cathode current collector 4 for collecting currents of the cathode layer 1, and anode current collector 5 for collecting currents of the anode layer 2. In the present disclosure, the cathode layer 1 or the anode layer 2 is the electrode layer described in “C. Electrode layer” above.

According to the present disclosure, usage of the above described electrode layer allows a battery to have less volume change due to charge and discharge. As described above, the electrode layer may be an anode layer and may be a cathode layer, but the former is preferable. Details of the battery when the electrode layer is the anode layer will be hereinafter explained.

### 1. Anode Layer

The anode layer is a layer containing at least an anode active material. The anode layer is in the same contents as those described in “C. Electrode layer” above; thus, the descriptions herein are omitted.

### 2. Cathode Layer

The cathode layer is a layer containing at least a cathode active material. Also, the cathode layer may contain at least one of an electrolyte, a conductive material, and a binder, as required.

Examples of the cathode active material may include an oxide active material. Examples of the oxide active material may include a rock salt bed type active material such as LiCoO₂, LiMnO₂, LiNiO₂, LiVO₂, and LiNi_{1/3}CO_{1/3}Mn_{1/3}O₂; a spinel type active material such as LiMn₂O₄, Li₄Ti₅O₁₂, and Li(Ni_{0.5}Mn_{1.5}) O₄; and an olivine type active material such as LiFePO₄, LiMnPO₄, LiNiPO₄, and LiCoPO₄.

A coating layer containing a Li-ion conductive oxide may be formed on the surface of the oxide active material. The reason therefor is to inhibit the reaction of the oxide active material and the solid electrolyte (particularly a sulfide solid electrolyte). Examples of the Li-ion conductive oxide may include LiNbO₃. The thickness of the coating layer is, for example, 1 nm or more and 30 nm or less. Also, as the cathode active material, for example, Li₂S can be used.

Examples of the shape of the cathode active material may include a granular shape. The average particle size (D₅₀) of the cathode active material is not particularly limited, and for example, it is 10 nm or more, and may be 100 nm or more. Meanwhile, the average particle size (D₅₀) of the cathode active material is, for example, 50 μm or less, and may be 20 μm or less.

The electrolyte used for the cathode layer is in the same contents as those described in “3. Electrolyte layer”. Also, the conductive material and the binder to be used for the cathode layer are in the same contents as those described in “B. Electrode mixture” above; thus, the descriptions herein are omitted. The thickness of the cathode layer is, for example, 0.1 μm or more and 1000 μm or less, may be 0.1 μm or more and 500 μm or less, and may be 0.1 μm or more and 100 μm or less.

### 3. Electrolyte Layer

The electrolyte layer is a layer formed between the cathode layer and the anode layer, and contains at least an electrolyte. The electrolyte may be a solid electrolyte and may be an electrolyte solution (liquid electrolyte).

The solid electrolyte is in the same contents as those described in “B Electrode layer” above; thus, the descriptions herein are omitted. Meanwhile, the liquid electrolyte preferably contains a supporting electrolyte (lithium salt) and a solvent. Examples of the supporting electrolyte of the electrolyte including lithium ion conductivity may include an inorganic lithium salt such as LiPF₆, LiBF₄, LiClO₄, and LiAsF₆; and an organic lithium salt such as LiCF₃SO₃, LiN(CF₃SO₂)₂, LiN(C₂F₅SO₂)₂, LiN(FSO₂)₂, and LiC(CF₃SO₂)₃. Examples of the solvent used for the electrolyte may include a cyclic ester (cyclic carbonate) such as ethylene carbonate (EC), propylene carbonate (PC) and butylene carbonate (BC); and a chain ester (chain carbonate) such as dimethyl carbonate (DMC), diethyl carbonate (DEC), and ethyl methyl carbonate (EMC). It is preferable that the liquid electrolyte contains two kinds or more of the solvent.

The thickness of the electrolyte layer is, for example, 0.1 μm or more and 1000 μm or less, may be 0.1 μm or more and 500 μm or less, and may be 0.1 μm or more and 100 μm or less.

### 4. Other Constitutions

The battery in the present disclosure preferably includes a cathode current collector for collecting currents of the cathode layer, and an anode current collector for collecting currents of the anode layer. Examples of the material for the cathode current collector may include SUS, aluminum, nickel, iron, titanium, and carbon. Meanwhile, examples of the material for the anode current collector may include SUS, copper, nickel, and carbon.

The battery in the present disclosure may further include a restraining jig that applies a restraining pressure along with the thickness direction of the cathode layer, the electrolyte layer and the anode layer. In particular, when the electrolyte layer is a solid electrolyte layer, it is preferable to apply a restraining pressure to form excellent ion conducting path and electron conducting path. The restraining pressure is, for example, 0.1 MPa or more, may be 1 MPa or more, and may be 5 MPa or more. Meanwhile, the restraining pressure is, for example, 100 MPa or less, may be 50 MPa or less, and may be 20 MPa or less.

### 5. Battery

The kind of the battery in the present disclosure is not particularly limited, but is typically a lithium ion battery. Also, the battery in the present disclosure may be a liquid battery in which the electrolyte layer contains a liquid electrolyte, and may be a solid state battery in which the electrolyte layer contains a solid electrolyte. The solid state battery may be a semisolid state battery and may be an all solid state battery. In the present disclosure, the semisolid state battery is a battery in which the electrolyte layer includes an inorganic solid electrolyte and a liquid component (such as ionic solution). In the present disclosure, the all solid state battery is a battery in which the electrolyte layer includes only the inorganic solid electrolyte as the electrolyte. Also, the battery in the present disclosure may be a primary battery and may be a secondary battery, but preferably a secondary battery among them. The reason therefor is to be repeatedly charged and discharged and useful as a car-mounted battery for example.

Examples of the applications of the battery may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably used as a power source for driving hybrid electric vehicles (HEV), plug-in hybrid electric vehicles (PHEV), and battery electric vehicles (BEV). Also, the battery may be used as a power source for moving bodies other than vehicles (such as rail road transportation, vessel and airplane), and may be used as a power source for electronic products such as information processing equipment.

### E. Method for Producing Electrode Active Material

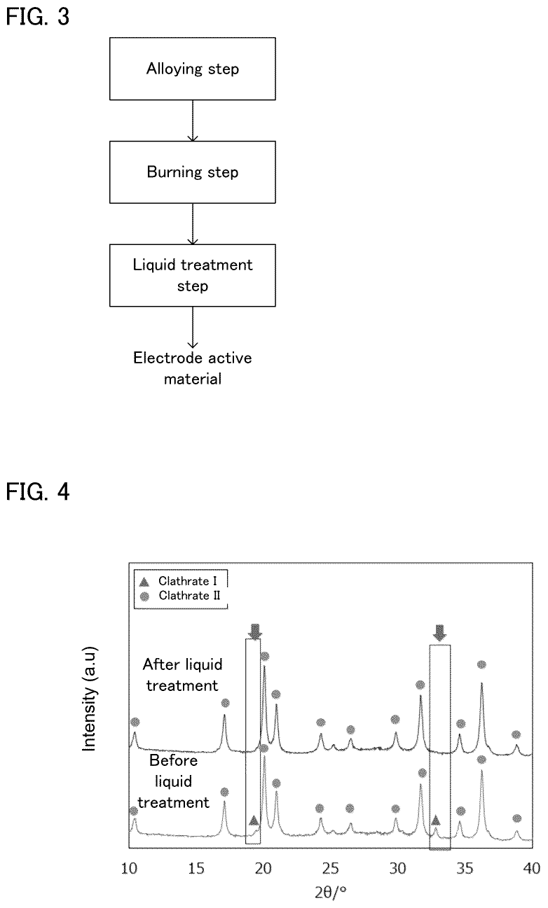

FIG. 3 is a flow chart exemplifying the method for producing the electrode active material in the present disclosure. In the production method shown in FIG. 3, first, a Na—Si alloy is obtained by bringing a Na source and a Si source into reaction (an alloying step). Next, the Na—Si alloy is burned to decrease Na amount in the Na—Si alloy and form a precursor active material including a silicon clathrate II type crystal phase (a burning step). Next, a liquid treatment is performed to the precursor active material using a hydrofluoric acid to obtain an electrode active material (a liquid treatment step). In the present disclosure, the concentration of the hydrofluoric acid is 3 weight % or more, and the treatment time in the liquid treatment step is 3 hours or more and less than 24 hours.

According to the present disclosure, by performing the liquid treatment step, an electrode active material of which volume change due to charge and discharge is small can be obtained.

### 1. Alloying Step

The alloying step in the present disclosure is a step of obtaining a Na—Si alloy by bringing a Na source and a Si source into reaction.

The Si source is a particle containing at least Si. The Si source may be a simple substance of Si, and may be an alloy of Si with other metals. When the Si source is an alloy, the alloy preferably contains Si as a main component. The proportion of Si in the alloy is, for example, 50 at % or more, may be 70 at& or more, and may be 90 at % or more.

The Si source is preferable a porous Si including a lot of voids inside the primary particle. Examples of the method for producing the Si source (porous Si) may include a method in which an alloy of Li with Si (Li—Si alloy) is produced and then Li is removed from the Li—Si alloy. The Li—Si alloy may be obtained by, for example, mixing Li and Si. The rate of Li with respect to Si, which is Li/Si is, for example, 1.0 or more, may be 2.0 or more, may be 3.0 or more, and may be 4.0 or more. Meanwhile, Li/Si is, for example, 8.0 or less. Examples of the method for removing Li from the Li—Si alloy may include a method in which the Li—Si alloy is brought into reacting with Li extracting agent. Examples of the Li extracting agent may include alcohol such as methanol, ethanol, 1-propanol, 1-butanol, 1-pentanol, and 1-hexanol; and acid such as acetic acid, formic acid, propionic acid, and oxalic acid.

Also, examples of the method for producing the Si source (porous Si) may include a method in which an alloy of Mg with Si (Mg—Si alloy) is produced, and then Mg is removed from the Mg—Si alloy. The Mg—Si alloy can be obtained by, for example, heating a mixture of Mg and Si. The rate of Mg with respect to Si, which is Mg/Si is, for example, 1.0 or more, may be 1.5 or more, and may be 2.0 or more. Meanwhile, Mg/Si is, for example, 6.0 or less. Examples of the method for removing Mg from the Mg—Si alloy may include a method in which Mg in the Mg—Si alloy is changed to MgO by heating the Mg—Si alloy in an inert gas atmosphere containing oxygen, and then MgO is removed by an acid solution. Examples of the acid solution may include an aqueous solution containing hydrochloric acid (HCl) and hydrogen fluoride (HF).

Also, examples of the method for producing the Si source (porous Si) may include a method in which an alloy of Mg with Si (Mg—Si alloy) is produced, and then Mg is removed from the Mg—Si alloy, and thereafter an alloy of Li with Si obtained by removing Mg (Li—Si alloy) is produced, and then Li is removed from the Li—Si alloy.

Meanwhile, the Na source contains at least Na. Examples of the Na source may include a metal Na, NaH, and a metal Na dispersion in which metal Na particles are dispersed in an oil.

Examples of the method for obtaining the Na—Si alloy by bringing the Na source and the Si source into reaction may include a method in which a mixture including the Na source and the Si source is heated. The heating temperature is, for example, 300° C. or more, may be 310° C. or more, may be 320° C. or more, and may be 340° C. or more. Meanwhile, the heating temperature is, for example, 800° C. or less, may be 600° C. or less, and may be 450° C. or less. Also, the alloying step is preferably performed under an inert atmosphere such as an Ar atmosphere.

The Na—Si alloy preferably includes a Zintl phase. The Zintl phase includes typical peaks at the positions of 20=16.10°, 16.56°, 17.64°, 20.16°, 27.96°, 33.60°, 35.68°, 40.22°, and 41.14° in an X-ray diffraction measurement using a CuKα ray. Each of these peaks may shift in the range of +0.50°, and may shift in the range of +0.30°. The Na—Si alloy preferably includes the Zintl phase as a main phase.

The composition of the Na—Si alloy is not particularly limited, but is preferably represented by the composition of Na₂Si₁₃₆ (121≤z≤151). The “z” may be 126 or more, and may be 131 or more. Meanwhile, the “z” may be 141 or less. There may be additional element other than Na and Si in the Na—Si alloy. Examples of the additional element may include Li, K, Rb, Cs, Ba, Ga, and Ge.

### 2. Burning Step

The burning step in the present disclosure is a step of burning the Na—Si alloy to decrease Na amount in the Na—Si alloy and form a precursor active material including a silicon clathrate II type crystal phase.

Burning conditions of the Na—Si alloy are appropriately adjusted so as to obtain the desired precursor active material. The burning temperature is, for example, 300° C. or more and 400° C. or less. Meanwhile, the burning time is, for example, 5 hours or more and 120 hours or less. The burning step may be performed in a reduced pressure atmosphere, and may be performed in a normal pressure atmosphere.

In the burning step, a capturing agent that captures Na in the Na—Si alloy is preferably used. Examples of the capturing agent may include a Na getter agent that reacts with a vapor of Na generated from the Na—Si alloy. The Na getter agent is, for example, arranged in a state not in contact with the Na—Si alloy. Examples of the Na getter agent may include SiO, MoO₃, FeO, and Fe₃O₄. In the case of using the Na getter agent, the burning step is preferably performed in the reduced pressure atmosphere.

Other examples of the capturing agent may include a Na trapping agent that directly reacts with the Na—Si alloy and receives Na. The Na trapping agent is, for example, arranged in a state in contact with the Na—Si alloy. Examples of the Na trapping agent may include CaCl₂), AlF₃, CaBr₂, CaI₂, Fe₃O₄, FeO, MgCl₂, ZnO, ZnCl₂, and MnCl₂. In the case of using the Na trapping agent, the burning step may be performed in a reduced pressure atmosphere, and may be performed in a normal pressure atmosphere.

### 3. Liquid Treatment Step

The liquid treatment step in the present disclosure is a step of performing a liquid treatment to the precursor active material using a hydrofluoric acid. The hydrofluoric acid is an aqueous solution in which a hydrogen fluoride (HF) is dissolved in water.

The concentration of the hydrogen fluoride in the hydrofluoric acid is usually 3 weight % or more, may be 4 weight % or more, and may be 5 weight % or more. Meanwhile, the concentration of hydrogen fluoride in the hydrofluoric acid is, for example, 10 weight % or less. Also, the treatment time of the liquid treatment is usually 3 hours or more, may be 4 hours or more, and may be 5 hours or more. Meanwhile, the treatment time of the liquid treatment is usually less than 24 hours, may be 15 hours or less, and may be 10 hours or less. The temperature of the liquid treatment is not particularly limited, but for example it is a normal temperature.

Examples of the method for performing the liquid treatment to the precursor active material with the hydrofluoric acid may include a method in which the precursor active material is soaked in the hydrofluoric acid, and a method in which the hydrofluoric acid is applied on the precursor active material.

### 4. Electrode Active Material

The electrode active material obtained by each steps described above includes the silicon clathrate II type crystal phase. Also, in the electrode active material, it is preferable that a void amount P₁ of a void with a pore diameter of 5 nm or less is 0.015 cc/g or more and 0.05 cc/g or less. Preferable aspects of the electrode active material are in the same contents as those described in “A. Electrode active material” above.

### F. Method for Producing Electrode Mixture

The present disclosure provides a method for producing an electrode mixture, the method including: a preparing step of preparing an electrode active material by the above described method for producing an electrode active material; and a mixing step of mixing the electrode active material and at least one of a conductive material and a binder to obtain an electrode mixture.

According to the present disclosure, by using the above described electrode active material, the electrode mixture of which volume change due to charge and discharge is small can be obtained. The preparing step is in the same contents as those described in “E. Method for producing electrode active material” above.

The electrode mixture usually contains the electrode active material, and at least one of a conductive material and a binder. The conductive material and the binder are in the same contents as those described in “B. Electrode mixture” above. The electrode mixture may or may not further include a dispersion medium. Also, the electrode mixture is usually obtained by mixing the electrode active material and at least one of the conductive material and the binder. There are no particular limitations on the method for mixing, and known methods can be used. Also, preferable aspects of the electrode mixture to be obtained are in the same contents as those described in “B Electrode mixture” above.

### G. Method for Producing Electrode Layer

The present disclosure provides a method for producing an electrode layer, the method including: a preparing step of preparing an electrode active material by the above described method for producing an electrode active material; a mixing step of mixing the electrode active material and at least one of a conductive material and a binder to obtain an electrode mixture; and an electrode layer forming step of forming an electrode layer using the electrode mixture.

According to the present disclosure, by using the above described electrode active material, the electrode layer of which volume change due to charge and discharge is small can be obtained. The preparing step and the mixing step are in the same contents as those described in “E. Method for producing electrode active material” above and “F. Method for producing electrode mixture” above.

The electrode layer forming step is a step of forming an electrode layer using the electrode mixture. There are no particular limitations on the method for forming the electrode layer, and known methods can be used. Examples of the method for forming the electrode layer may include a method in which the electrode mixture is applied on the electrode current collector. On the occasion of forming the electrode layer, a pressing treatment of pressing the electrode layer in a thickness direction may be performed. Examples of the pressing treatment may include a roller pressing and a flat plate pressing. Also, when the electrode mixture is a slurry containing a dispersion medium, drying is preferably performed after applying the electrode mixture on the electrode current collector.

The electrode layer forming step may be a cathode layer forming step of forming a cathode layer, and may be an anode layer forming step of forming an anode layer.

### H. Method for Producing Battery

The present disclosure provides a method for producing a battery, the method including: a preparing step of preparing an electrode active material by the above described method for producing an electrode active material; a mixing step of mixing the electrode active material and at least one of a conductive material and a binder to obtain an electrode mixture; and an electrode layer forming step of forming an electrode layer using the electrode mixture.

According to the present disclosure, by using the above described electrode active material, the battery of which volume change due to charge and discharge is small can be obtained. The preparing step, the mixing step and the electrode layer forming step are in the same contents as those described in “E. Method for producing electrode active material” above, “F. Method for producing electrode mixture” above, and “G. Method for producing electrode layer” above. The method for producing a battery in the present disclosure may further include additional step such as an electrolyte layer forming step of forming an electrolyte layer. Also, preferable aspects of the battery to be obtained are in the same contents as those described in “D. Battery” above.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Comparative Example 1

Metal Li and Si powder were weighed so as to be 4:1 in the molar ratio, and brought into reaction by mixing with a mortar in the conditions of under an Ar atmosphere, at a room temperature, and for 0.5 hours. Thereby, Li₄Si was obtained. The obtained Li₄Si was brought into reaction with ethanol under an Ar atmosphere. The obtained reaction product was considered to include Si and CH₃CH₂OLi. This reaction product was filtrated, and the filtrated solid content was dried at 120° C. for 3 hours or more to obtain powder porous Si.

A Na—Si alloy was produced using the obtained porous Si, and using NaH as a Na source. Incidentally, as the NaH, the one washed by hexane in advance was used. The NaH and the porous Si were weighed so as to be 1.05:1 in the molar ratio, and mixed using a cutter mill. The mixture of the NaH and the porous Si was heated in the conditions of under an Ar atmosphere, at 475° C. and for 40 hours in a heating furnace to obtain a powder Na—Si alloy.

A silicon clathrate was generated by a solid phase method using the obtained Na—Si alloy, and further using AlF₃ as a Na trapping agent. The Na—Si alloy and the AlF₃ were weighed so as to be 1:0.35 in the molar ratio, and mixed using a cuter mill to obtain a reaction raw material. The obtained powder reaction raw material was put in a reaction container made of stainless steel, and brought into reaction by heating in the conditions of under an Ar atmosphere, at 310° C. and for 60 hours in a heating furnace to obtain a precursor active material.

The obtained precursor active material was considered to include NaF and Al as by-products. Then, the precursor active material was washed using a mixture solvent in which HNO₃ and H₂O were mixed in the volume ratio of 10:90. Thereby, the by-products in the reaction product were eliminated. After washing, filtrated and separated solid content was dried at 120° C. for 3 hours or more to obtain powder. Further, 5 g of the obtained powder was weighed and taken out, and a liquid treatment was performed thereto using a HF aqueous solution with the concentration of 3 weight % for 1 hour. After the liquid treatment, filtrated and separated solid content was dried at 120° C. for 3 hours or more to obtain an electrode active material.

### Comparative Example 2

An electrode active material was obtained in the same manner as in Comparative Example 1, except that the metal Li and Si powder were used in the molar ratio of 4.75:1 on the occasion of producing the powder porous Si, and the heating was performed in the conditions of under an Ar atmosphere, at 400° C. and for 40 hours in a heating furnace on the occasion of producing the powder Na—Si alloy.

### Example 1

An electrode active material was obtained in the same manner as in Comparative Example 1, except that the metal Li and Si powder were used in the molar ratio of 4.75:1 on the occasion of producing the powder porous Si, and the treatment time was changed to 3 hours on the occasion of the liquid treatment with the HF aqueous solution.

### Example 2

An electrode active material was obtained in the same manner as in Comparative Example 1, except that the metal Li and Si powder were used in the molar ratio of 4.75:1 on the occasion of producing the powder porous Si, and the treatment time was changed to 5 hours on the occasion of the liquid treatment with the HF aqueous solution.

### Example 3

An electrode active material was obtained in the same manner as in Comparative Example 1 except that the treatment time was changed to 5 hours on the occasion of the liquid treatment with the HF aqueous solution.

### Comparative Example 3

An electrode active material was obtained in the same manner as in Comparative Example 1, except that the metal Li and Si powder were used in the molar ratio of 4.75:1 on the occasion of producing the powder porous Si, the concentration was changed to 1 weight % on the occasion of the liquid treatment with the HF aqueous solution, and the treatment time was changed to 5 hours.

### Comparative Example 4

An electrode active material was obtained in the same manner as in Comparative Example 1, except that the metal Li and Si powder were used in the molar ratio of 4.75:1 on the occasion of producing the powder porous Si, and the treatment time was changed to 24 hours on the occasion of the liquid treatment with the HF aqueous solution.

### Comparative Example 5

Crystal Si (SIEPB23 from Kojundo Chemical Laboratory Co., Ltd.) was prepared, and an atomization was performed thereto by mechanical milling. In specific, 1 g of the crystal Si and 53 g of zirconia balls having φ1 mm were put in a container and sealed, and the mechanical milling was performed in the conditions of 200 rpm and 3 hours using a planetary ball mill (from Fritsch). After that, the liquid treatment was preformed using a HF aqueous solution having the concentration of 3 weight %. After the liquid treatment, filtrated and separated solid content was dried at 120° C. for 3 hours or more to obtain an electrode active material. The conditions of the liquid treatment to the electrode active materials in Examples 1 to 3, and Comparative Examples 1 to 5 are shown in Table 1.

TABLE 1

| | HF | Treatment | | Proportion of |
|---|---|---|---|---|
| | concentration | time | | clathrate I type |
| | [wt %] | [h] | Si structure | [wt %] |
| Comp. Ex. 1 | 3 | 1 | Clathrate | 15 |
| Comp. Ex. 2 | 3 | 1 | Clathrate | 13 |
| Example 1 | 3 | 3 | Clathrate | 16 |
| Example 2 | 3 | 5 | Clathrate | 13 |
| Example 3 | 3 | 5 | Clathrate | 12 |
| Comp. Ex. 3 | 1 | 5 | Clathrate | 14 |
| Comp. Ex. 4 | 3 | 24 | Clathrate | 16 |
| Comp. Ex. 5 | 3 | 5 | Diamond | 0 |

### Evaluation

### <Xrd Measurement>

An X-ray diffraction (XRD) measurement using CuKα ray was respectively performed to the electrode active materials obtained in Examples 1 to 3 and Comparative Examples 1 to 4. As a result, it was confirmed that all the electrode active materials had the silicon clathrate II type crystal phase as a main phase.

In the silicon clathrate II type crystal phase, an intensity of peak A positioned in the vicinity of 20=20.09° was regarded as I_{A}, and an intensity of peak B positioned in the vicinity of 20=31.72° was regarded as I_{B}. Also, the maximum intensity in 20=22° to 23° was regarded as I_{M}, and I_{A}/I_{M} and I_{B}/I_{M} were obtained. As a result, I_{A}/I_{M} was larger than 1 and I_{B}/I_{M} was larger than 1 in all the electrode active materials obtained in Examples 1 to 3 and Comparative Examples 1 to 4

Also, in Examples 1 to 3 and Comparative Examples 1 to 4, the proportion of the silicon clathrate I type crystal phase before the liquid treatment with the HF aqueous solution was obtained by a RIR method (Reference Intensity Ratio method). The results are shown in Table 1. As shown in Table 1, it was confirmed that the precursor active material included the silicon clathrate I type crystal phase before the liquid treatment with the HF aqueous solution. Also, as shown in FIG. 4, it was confirmed that the silicon clathrate I type crystal phase disappeared before and after the liquid treatment with the HF aqueous solution.

### <Measurement of Void Amount>

The void amounts of the electrode active materials obtained in Examples 1 to 3 and Comparative Examples 1 to 5 were obtained. In specific, the void amount P₁ with the pore diameter of 5 nm or less, the void amount P₂ with the pore diameter of 10 nm or less, and the void amount P₃ with the pore diameter of 100 nm or less were obtained using a high accuracy gas absorption amount measurement device (BELSORP MAXII from microtrac bel). The results are shown in Table 2.

### <Specific Surface Area Measurement>

The BET specific surface area of the electrode active materials obtained in Examples 1 to 3 and Comparative Examples 1 to 5 was respectively obtained using the specific surface area measurement device. The results are shown in Table 2.

TABLE 2

| | Void amount P [cc/g] | | | | | |
|---|---|---|---|---|---|---|
| | P₁ | P₂ | P₃ | | | |
| | (0-5 | (0-10 | (0-100 | P₁/P₂ | P₁/P₃ | BET(X) |
| | nm) | nm) | nm) | [%] | [%] | [m²/g] |
| Comp. Ex. 1 | 0.0080 | 0.0195 | 0.390 | 40.9 | 2.05 | 54.6 |
| Comp. Ex. 2 | 0.0136 | 0.0854 | 0.253 | 15.9 | 5.38 | 63.0 |
| Example 1 | 0.023 | 0.040 | 0.33 | 57.5 | 6.97 | 64.7 |
| Example 2 | 0.035 | 0.058 | 0.38 | 60.3 | 9.21 | 80.4 |
| Example 3 | 0.0257 | 0.0400 | 0.32 | 64.2 | 8.02 | 52.5 |
| Comp. Ex. 3 | 0.0146 | 0.0165 | 0.232 | 88.4 | 6.28 | 61.5 |
| Comp. Ex. 4 | 0.0003 | 0.0054 | 0.102 | 5.9 | 0.31 | 63 |
| Comp. Ex. 5 | 0.0013 | 0.0367 | 0.473 | 3.5 | 0.27 | 48 |

As shown in Table 2, it was confirmed that the void amount P₁ with the pore diameter of 5 nm or less was more in electrode active materials obtained in Examples 1 to 3, compared to the electrode active materials obtained in Comparative Examples 1 to 5. The silicon clathrate I type crystal phase is more easily dissolved in the HF aqueous solution compared to the silicon clathrate II type crystal phase, and thus it was presumed that the silicon clathrate I type crystal phase disappeared due to the liquid treatment with the HF aqueous solution, and the void amount P₁ with the pore diameter of 5 nm or less increased.

### <Production of all Solid State Battery>

An all solid state battery was respectively produced using the electrode active materials obtained in Examples 1 to 3 and Comparative Examples 1 and 2 as the anode active material. The production method was as follows.

### (1) Production of Anode

The obtained electrode active material, a sulfide solid electrolyte (Li₂S—P₂S₅-based glass ceramic), a conductive material (VGCF), a butyl butyrate solution containing a PVDF-based binder in the ratio of 5 weight %, and butyl butyrate were added to a container made of polypropylene, and agitated for 30 seconds by an ultrasonic dispersion device (UH-50 from SMT Corporation). Next, the container was shaken for 30 minutes by a shaker (TTM-1 from SIBATA SCIENTIFIC TECHNOLOGY LTD.). The product was applied on an anode current collector (Cu foil from UACJ) by a blade method using an applicator, and dried on a hot plate at 100° C. for 30 minutes. Thereby, an anode including an anode current collector and an anode layer was obtained.

### (2) Production of Cathode

A cathode active material (LiNi_{1/3}CO_{1/3}Mn_{1/3}O₂, average particle diameter 6 μm), a sulfide solid electrolyte (Li₂S—P₂S₅-based glass ceramic), a conductive material (VGCF), a butyl butyrate solution containing a PVDF-based binder in the ratio of 5 weight %, and butyl butyrate were added to a container made of polypropylene, and agitated for 30 seconds by an ultrasonic dispersion device (UH-50 from SMT Corporation). Next, the container was shaken for 3 minutes by a shaker (TTM-1 from SIBATA SCIENTIFIC TECHNOLOGY LTD.), further agitated by the ultrasonic dispersion device for 30 seconds, and then shaken for 3 minutes by the shaker. The product was applied on a cathode current collector (Al foil from SHOWA DENKO K.K) by a blade method using an applicator, and dried on a hot plate at 100° C. for 30 minutes. Thereby, a cathode including a cathode current collector and a cathode layer was obtained. Incidentally, the area of the cathode was made smaller than the area of the anode.

### (3) Production of Solid Electrolyte Layer

A sulfide solid electrolyte (Li₂S—P₂S₅-based glass ceramic), a heptane solution containing a butylene rubber-based binder in the ratio of 5 weight %, and heptane were added to a container made of polypropylene, and agitated for 30 seconds by an ultrasonic dispersion device (UH-50 from SMT Corporation). Next, the container was shaken for 30 minutes by a shaker (TTM-1 from SIBATA SCIENTIFIC TECHNOLOGY LTD.). The product was applied on a peeling sheet (Al foil) by a blade method using an applicator, and dried on a hot plate at 100° C. for 30 minutes. Thereby, a transfer member including the peeling sheet and the solid electrolyte layer was obtained.

### (4) Production of all Solid State Battery

A solid electrolyte layer for bonding was arranged on the cathode layer in the cathode, and installed to a roll-pressing machine, then pressed at 100 kN/cm and 165° C. Thereby, a first layered body was obtained.

Next, the anode was installed to the roll-pressing machine and pressed at 60 kN/cm and 25° C. Thereby, a pressed anode was obtained. After that, in the order from the anode layer side, the solid electrolyte layer for bonding and the transfer member were arranged. On this occasion, the solid electrolyte layer for bonding and the solid electrolyte layer in the transfer member were arranged so as to face to each other. The obtained layered body was installed to a plane uniaxial pressing machine and provisionally pressed at 100 MPa and 25° C. for 10 seconds. After that, the peeling sheet was peeled off from the solid electrolyte layer. Thereby, a second layered body was obtained.

Next, the solid electrolyte layer for bonding in the first layered body and the solid electrolyte layer in the second layered body were arranged so as to face to each other, installed to a plane uniaxial pressing machine, and pressed at 200 MPa and 120° C. for 1 minute. Thereby, an all solid state battery was obtained.

### (5) Measurement of Void Amount and Volume Expansion Rate

The void amount of the pressed anode was obtained. In specific, the void amount Q₁ with the pore diameter of 5 nm or less, the void amount Q₂ with the pore diameter of 10 nm or less, and the void amount Q₃ with the pore diameter of 100 nm or less were obtained using a high accuracy gas absorption amount measurement device (BELSORP MAXII from microtrac bel). The results are shown in Table 3. Also, the obtained all solid state battery was respectively charged, and the volume expansion rate was respectively measured. The test conditions were the restraining pressure (constant rate) of 5 MPa, charge at 0.1 C, and the cut voltage of 4.55 V, and the restraining pressure at 4.55 V was measured, the restraining pressure increase amount from the state before charge was obtained, and the volume expansion rate was obtained. The results are shown in Table 3. Incidentally, the results of the volume expansion rate in Table 3 are the relative values when the result of Comparative Example 1 is regarded as 100. Also, the changes of the void amount by pressing are shown in Table 4.

TABLE 3

| | Void amount Q [cc/g] | | | | | Expansion |
|---|---|---|---|---|---|---|
| | Q₁ | Q₂ | Q₃ | Q₁/Q₂ | Q₁/Q₃ | rate |
| | (0-5 nm) | (0-10 nm) | (0-100 nm) | [%] | [%] | [%] |
| Comp. Ex. 1 | 0.0048 | 0.0104 | 0.086 | 46.2 | 5.57 | 100 |
| Comp. Ex. 2 | 0.0077 | 0.0351 | 0.087 | 21.9 | 8.85 | 82 |
| Example 1 | 0.0132 | 0.0232 | 0.09731 | 56.9 | 13.56 | 61 |
| Example 2 | 0.0233 | 0.0323 | 0.1191 | 72.1 | 19.57 | 48 |
| Example 3 | 0.0155 | 0.0212 | 0.09371 | 73.1 | 16.54 | 52 |

TABLE 4

| | Q₁/P₁ | Q₂/P₂ | Q₃/P₃ |
|---|---|---|---|
| | [%] | [%] | [%] |
| Comp. Ex. 1 | 60 | 53 | 22 |
| Comp. Ex. 2 | 57 | 41 | 34 |
| Example 1 | 57 | 58 | 29 |
| Example 2 | 67 | 56 | 31 |
| Example 3 | 60 | 53 | 29 |

As shown in Table 3, it was confirmed that the void amount Q₁ with the pore diameter of 5 nm or less was more in the electrode active materials obtained in Examples 1 to 3, compared to the electrode active materials obtained in Comparative Examples 1 and 2. Also, as shown in Table 4, it was confirmed that Q₁/P₁ was larger than Q₂/P₂, and the void with the pore diameter of 5 nm or less was not easily crashed by pressing. Also, as shown in Table 3, it was confirmed that the volume expansion rate was reduced in Examples 1 to 3 compared to Comparative Examples 1 and 2. In particular, the volume expansion rate of Examples 2 and 3 was respectively remarkably reduced compared to Comparative Example 1.

### REFERENCE SINGS LIST

1 cathode layer
2 anode layer
3 electrolyte layer
4 cathode current collector
5 anode current collector
10 battery

What is claimed is:

1. An electrode active material comprising a silicon
clathrate II type crystal phase, wherein
a void is included inside a primary particle; and
a void amount P₁ of a void with a pore diameter of 5 nm or less is 0.015 cc/g or more and 0.05 cc/g or less.

2. The electrode active material according to claim 1, wherein a rate of the void amount P₁ with respect to a void amount P₂ of a void with a pore diameter of 10 nm or less, which is P₁/P₂, is 50% or more.

3. The electrode active material according to claim 1, wherein a void amount P₂ of a void with a pore diameter of 10 nm or less is 0.03 cc/g or more and 0.08 cc/g or less.

4. The electrode active material according to claim 1, wherein a rate of the void amount P₁ with respect to a void amount P₃ of a void with a pore diameter of 100 nm or less, which is P₁/P₃, is 6.5% or more.

5. The electrode active material according to claim 1, wherein a void amount P₃ of a void with a pore diameter of 100 nm or less is 0.1 cc/g or more and 0.5 cc/g or less.

6. The electrode active material according to claim 1, wherein the electrode active material includes the silicon clathrate II type crystal phase as a main phase.

7. An electrode mixture comprising the electrode active material according to claim 1, and at least one of a conductive material and a binder.

8. The electrode mixture according to claim 7, further comprising a solid electrolyte.

9. The electrode mixture according to claim 8, wherein the solid electrolyte included in the electrode mixture is a sulfide solid electrolyte.

10. An electrode layer to be used in a battery, the electrode layer comprising:
an electrode active material including a silicon clathrate II type crystal phase and a void inside a primary particle, wherein
a void amount Q₁ of a void with a pore diameter of 5 nm or less is 0.008 cc/g or more and 0.04 cc/g or less.

11. The electrode layer according to claim 10, wherein a rate of the void amount Q₁ with respect to a void amount Q₂ of a void with a pore diameter of 10 nm or less, which is Q₁/Q₂, is 50% or more.

12. The electrode layer according to claim 10, wherein a void amount Q₂ of a void with a pore diameter of 10 nm or less is 0.01 cc/g or more and 0.05 cc/g or less.

13. The electrode layer according to claim 10, wherein a rate of the void amount Q₁ with respect to a void amount Q₃ of a void with a pore diameter of 100 nm or less, which is Q₁/Q₃, is 10% or more.

14. The electrode layer according to claim 10, wherein a void amount Q₃ of a void with a pore diameter of 100 nm or less is 0.07 cc/g or more and 0.2 cc/g or less.

15. A battery comprising a cathode layer, an anode layer, and an electrolyte layer arranged between the cathode layer and the anode layer, wherein
the cathode layer or the anode layer is the electrode layer according to claim 10.

16. A method for producing an electrode active material, the method comprising:
an alloying step of obtaining a Na—Si alloy by bringing a Na source and a Si source into reaction;
a burning step of burning the Na—Si alloy to decrease Na amount in the Na—Si alloy and form a precursor active material including a silicon clathrate II type crystal phase; and
a liquid treatment step of performing a liquid treatment to the precursor active material using a hydrofluoric acid, wherein
a concentration of hydrogen fluoride in the hydrofluoric acid is 3 weight % or more; and
a treatment time in the liquid treatment step is 3 hours or more and less than 24 hours.

17. The method for producing an electrode active material according to claim 16, wherein, in the electrode active material, a void amount P₁ of a void with a pore diameter of 5 nm or less is 0.015 cc/g or more and 0.05 cc/g or less.

18. A method for producing an electrode mixture, the method comprising:
a preparing step of preparing an electrode active material by the method for producing an electrode active material according to claim 16; and
a mixing step of mixing the electrode active material and at least one of a conductive material and a binder to obtain an electrode mixture.

19. A method for producing an electrode layer, the method comprising:
a preparing step of preparing an electrode active material by the method for producing an electrode active material according to claim 16;
a mixing step of mixing the electrode active material and at least one of a conductive material and a binder to obtain an electrode mixture; and
an electrode layer forming step of forming an electrode layer using the electrode mixture.

20. A method for producing a battery, the method comprising:
a preparing step of preparing an electrode active material by the method for producing an electrode active material according to claim 16;
a mixing step of mixing the electrode active material and at least one of a conductive material and a binder to obtain an electrode mixture; and
an electrode layer forming step of forming an electrode layer using the electrode mixture.
